(19) United States
(12) Patent Application Publication
(10) Pub. No.: US 2008/0046097 A1
(43) Pub. Date: Feb. 21, 2008

(54) Graphical representation of setup state on multiple nodes

(75) Inventors: Edward K. Tremblay, Bellevue, WA (US); Mai-lan Tomsen Bukovec, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/506,512

(22) Filed: Aug. 18, 2006

(51) Int. Cl. G05B 15/00

(52) U.S. Cl. 700/1

(57) ABSTRACT

Aspects of the subject matter described herein relate to setting up nodes. In aspects, a setup process is started on a node to install software components to provide services to other nodes. The setup process may also install software components on other nodes to provide additional services. A management component displays a graphical representation of the setup state of the nodes. As the setup state changes, the management component changes the representation to correspond to the new setup state of the nodes. In addition, a user may hover a cursor over an icon representing a node to obtain information about the setup state of the node or other information about the node.

### BACKGROUND

As an organization grows, the number of servers used by the organization may also grow. For a small company, one server may be used to provide various services including file storage and retrieval, document management, Internet access, and e-mail. For a large company, these same services may be provided by hundreds of servers placed at various locations.

A large company typically has many specialized personnel dedicated to setting up and maintaining the computer resources controlled by the company. For example, one person may be in charge of setting up e-mail accounts, another person may be in charge of configuring routers, another person may be in charge of installing an application, and so forth.

Small and mid-size companies do not typically have such a team of specialists. Often one individual may be in charge of all the computer needs of the organization. Because the individual may not be aware of how servers may need to be configured, particularly in a multi-server setup, sub-optimal or incorrect configuration may occur.

### SUMMARY

Briefly, aspects of the subject matter described herein relate to setting up nodes. In aspects, a setup process is started on a node to install software components to provide services to other nodes. The setup process may also install software components on other nodes to provide additional services. A management component displays a graphical representation of the setup state of the nodes. As the setup state changes, the management component changes the representation to correspond to the new setup state of the nodes. In addition, during setup, a user may hover a cursor over an icon representing a node to obtain information about the setup state or other information about the node.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that illustrates some exemplary components of the management component in accordance with aspects of the subject matter described herein;

FIG. 4 is a representation of a window that includes an exemplary user interface that operates in accordance with aspects of the subject matter described herein;

FIGS. 5A and 5B show exemplary illustrations of messages that may be displayed when an icon is hovered over or clicked on in accordance with aspects of the subject matter described herein; and

FIG. 6 is a flow diagram that generally represents exemplary actions that may occur during a setup process in accordance with aspects of the subject matter described herein.

### DETAILED DESCRIPTION

### Exemplary Operating Environment

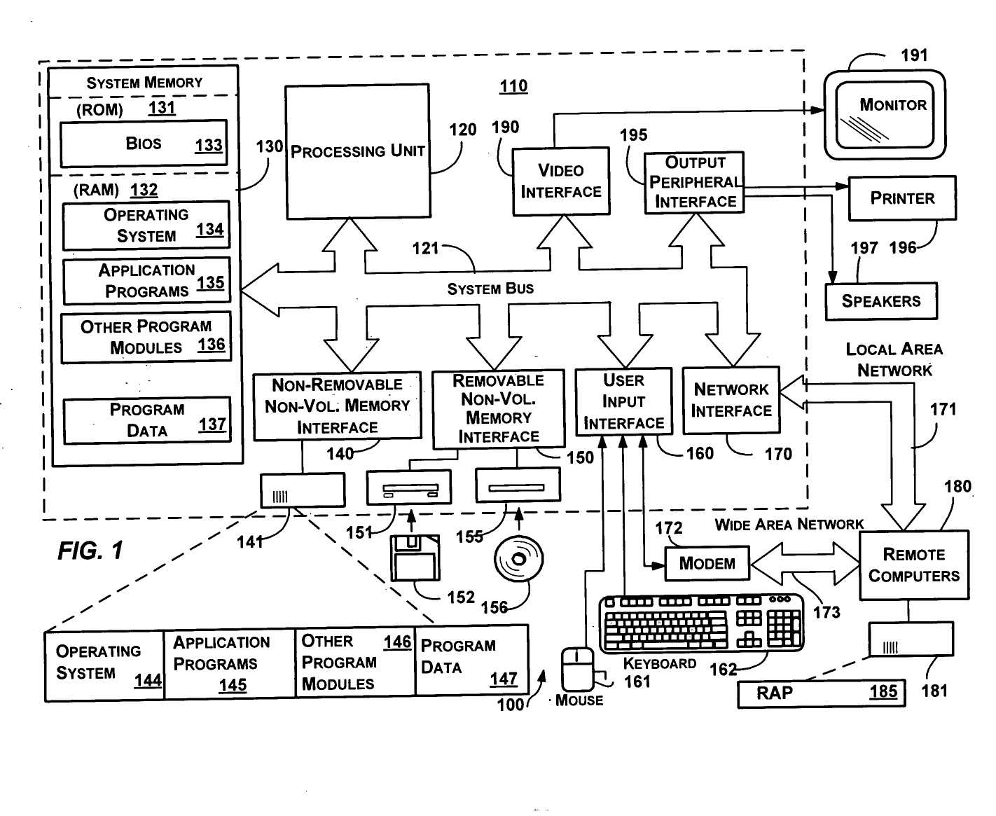

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Representation of Setup State

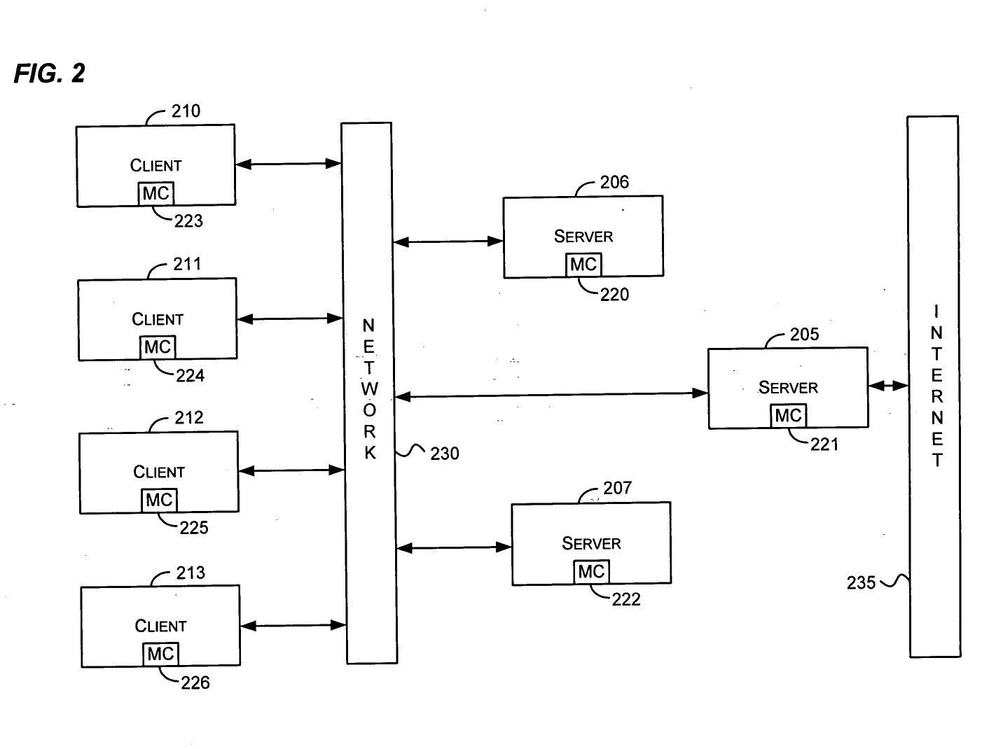

FIG. 2 is a block diagram representing an exemplary environment in which aspects of the subject matter described herein may be implemented. In one embodiment, the environment includes servers 205-207 and clients 210-213 and other components (not shown). In other embodiments, the number of servers and clients and the arrangement thereof may be changed without departing from the spirit or scope of aspects of the subject matter described herein. Clients and servers may communicate with each other and with other entities (e.g., routers, firewalls, and other entities not shown) via various networks including intra-office network 230 and the Internet 235.

Each of the servers 206-207 and the clients 210-213 may be implemented on one or more computers (e.g., computer 110 as described in conjunction with FIG. 1). The servers 205-207 may be configured, for example, to perform specific functions. In one embodiment, for example, the server 206 may be configured as a management server. In this embodiment, the server 206 may monitor the other nodes (e.g., clients 210-213 and servers 205 and 207) of a configuration set to determine whether the other nodes are operating correctly, up-to-date with respect to software versions and anti-virus signatures, and the like. When the server 206 determines that a node that it is monitoring is not operating correctly or is not up-to-date, the server 206 may display or send a message to a console or an email address for viewing by a system administrator or the like (hereinafter collectively referred to as a “system administrator” or “user”).

In addition, the server 206 may host a document repository in which documents, files, versions thereof, and the like may be stored. One exemplary document repository is SharePoint® produced by Microsoft Corporation of Redmond, Wash. In other embodiments, the server 206 may host other document repositories without departing from the spirit or scope of aspects of the subject matter described herein.

The server 206 may also host a directory service that stores and organizes information about a network's users, shares, and resources. The directory service may allow network administrators to control access to resources available through the network. Exemplary directory services include Network Information Service (NIS), eDirectory, Red Hat directory server, Active Directory, Open Directory, Apache Directory Server, and Oracle Internet Directory to name a few.

The server 206 may also host a Dynamic Host Configuration Protocol (DHCP) process that supplies each other local node with an IP address at which the node is accessible, a subnet mask, a default gateway, an IP address for a Windows® Internet Name Service (WINS) server, and an IP address for a Domain Name System (DNS) server.

The server 207 may include a replica of the directory service (and associated data) which may be used in case the directory service on the server 206 becomes non-operational or corrupt. In addition, the server 207 may include other applications, such as an e-mail server, calendaring software, a message store, an anti-virus engine that examines e-mails, and the like.

The server 205 may comprise an edge server that provides services such as access to resources and entities available on the Internet, 235, firewall capability, spam filtering, authentication of remote users attempting to access resources connected to the network 230, anti-virus monitoring, port filtering, port forwarding, and the like.

The functions provided by each of the servers 205-207 may be distributed differently among the servers 205-207, more or fewer servers, and/or other devices (e.g., stand-alone firewalls, routers, and the like) without departing from the spirit or scope of aspects of the subject matter described herein.

Management components (e.g., management components 220-226) may be included on the servers 206-207 and the clients 210-213. A management component may include a component arranged to interact with a system administrator and to display the state of each node included in the configuration set. In one embodiment, the management component is included on a set of server nodes only. In another embodiment, the management component is included on server and client nodes.

A setup process may be executed on each node that is to be setup to provide services (e.g., servers 206-207). In one embodiment, the setup process may be executed by logging on to a node, inserting media, accessing a shared network drive from the node, or otherwise accessing storage media and accessing a setup program, and executing the setup program on each of the nodes. After a node is setup enough to know where other nodes in its configuration set are located, the node may obtain configuration data from one or more of these other nodes during its setup. Such configuration data may include, for example, the addresses of servers (e.g., DNS servers, e-mail servers, directory service server, and the like).

In another embodiment, a service, process, or the like (e.g., a management component) executes on each node that is to be setup to provide services. A system administrator may log into any node and, via the service, may setup each node of a configuration set without logging on to each node from the node's console.

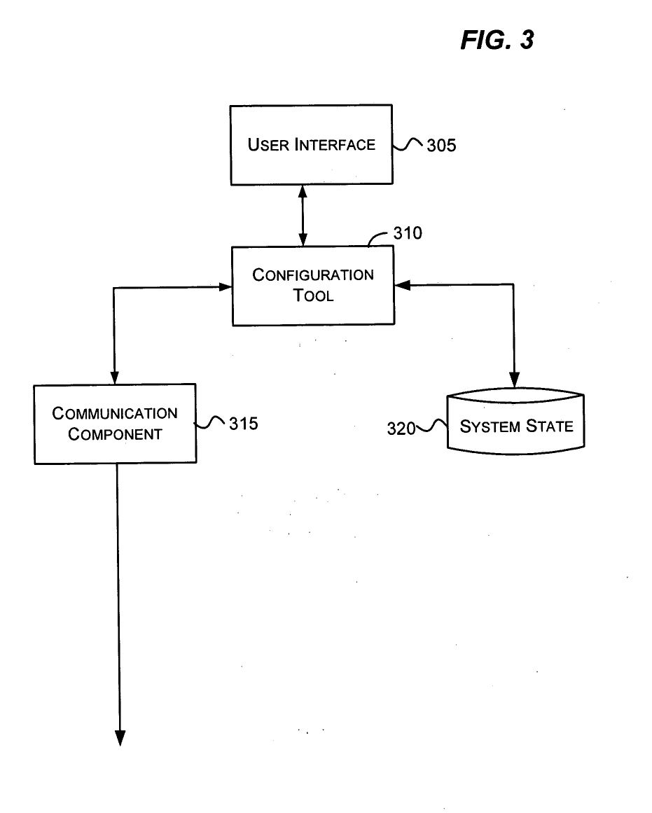

FIG. 3 is a block diagram that illustrates some exemplary components of the management component in accordance with aspects of the subject matter described herein. The components may include a user interface 405, a configuration tool 310, a communication component 315, and a system state 320. Examples of communication component 315 include modem 172 and network interface 170 of FIG. 1.

In one embodiment, the configuration tool 310 of a node with which the system administrator is interacting (e.g., via a keyboard and other input devices) communicates via the communication component 315 with the management components of other functioning nodes to obtain setup status. The other nodes may not be setup and may hence be unable to communicate with the configuration tool 310, may be in the process of being setup and may be able to communicate their progress to the configuration tool 310, or may have completed setup and be able to respond to inquiries from the configuration tool 310.

The configuration tool 310 may poll or be notified of the setup progress on the local and remote nodes. Based on the progress, the configuration tool 310 may change a graphical representation of the progress via the user interface 305.

The system state 320 may store the current state of a setup together with information needed during a setup (e.g., server addresses and names and so forth). In one embodiment, the system state 320 is stored in a central database which may be accessed by any node. In another embodiment, the system state 320 is stored in data distributed across one or more of the nodes.

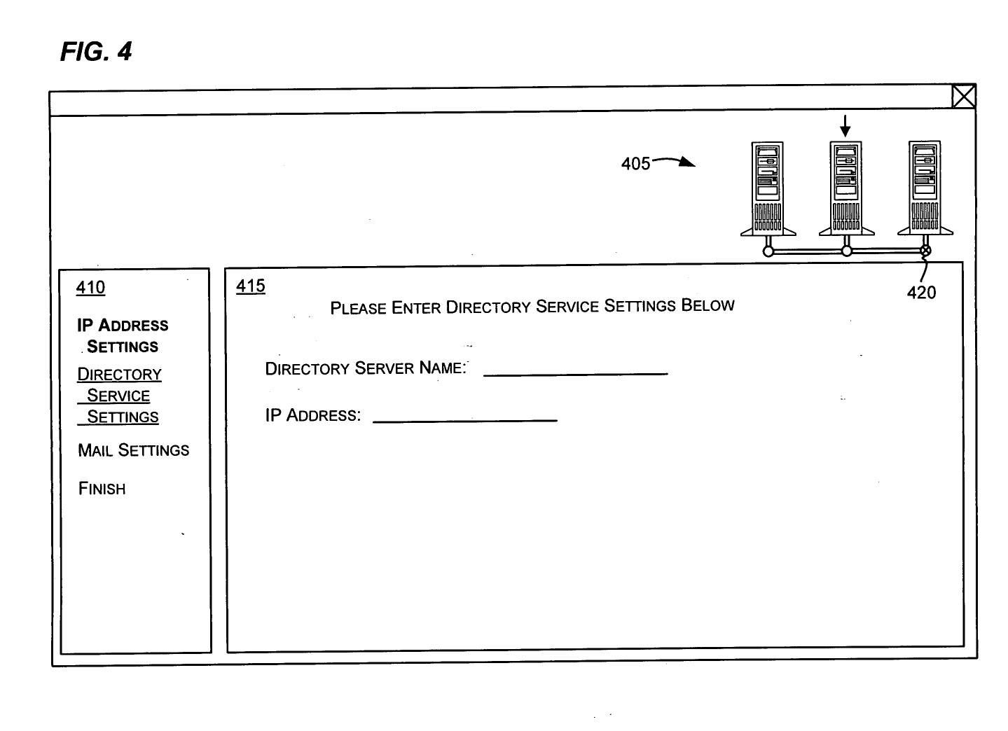

FIG. 4 is a representation of a window that includes an exemplary user interface that operates in accordance with aspects of the subject matter described herein. The window includes a graphical representation 405 of setup state, a progress pane 410, and an information pane 415. The window may include fewer or more icons, buttons, panes, and other graphical elements without departing from the spirit or scope of aspects of the subject matter described herein. The window may be updated dynamically when the setup state changes or may be updated periodically (e.g., every 30 seconds).

The graphical representation 405 shows three servers connected together by a network. More or fewer servers may be shown depending on how many servers are included in the configuration set. An arrow points to one of the servers to indicate that the server is currently being setup by the system administrator. In one embodiment, a graphical representation of one of the server's function is also displayed when the server is being configured. For example, when configuring a management server, a graphic indicating management functions (e.g., a bundle of wires) may be displayed next to the server. As another example, when configuring a server as an e-mail server, an envelope icon may be, displayed next to the server.

In another embodiment, the server that is currently being setup may be highlighted by, for example, being outlined in bold, displayed in another color, flashing, or some other graphical representation.

A graphical “X” 420 or some other graphical representation may be used to indicate that one of the servers is not configured to connect to other nodes in a network. The graphical “X” 420 may be colored red or some other color to make it stand out. When a server is configured to connect to other nodes in the network, its corresponding network link (e.g., the circles on the network below the servers) may be colored green or some other color. A server that has not been setup may not have network lines running to it. A server that has been setup but that is not currently able to communicate with other nodes in the network may show the graphical “X” 420. Animation (e.g., signals proceeding from servers through the network) may also be used to show connection state of a server.

Servers that have been setup may have a colored area associated with them. In one embodiment, this colored area is a circle underneath each server that has been setup. The colored area may appear to “light up” the servers that have been setup. Servers that have not been setup may be shaded in gray or some other color to indicate this state.

Hovering a cursor over a server or clicking on the server may cause a pop up to display text that indicates the setup state of the server. The text may include the server's name, server function (e.g., mail server, edge server, document server) and setup state (e.g., not setup, setup in progress, completely setup, functioning properly, and so forth). The text may also include links to a document or Web site for more information about the setup process or the product itself.

In one embodiment, the servers may be displayed in a topology that makes their function more apparent. For example, one of the servers may be shown connected to a cloud representing the Internet, another server may be shown next to mail, and another server may be shown next to documents. It will be recognized that many other representations may be used to denote the functions of servers without departing from the spirit or scope of the subject matter described herein.

For example, in one embodiment, the topology's elements (such as the cloud for the Internet connection) may be statically defined, where the picture elements remain visible. In this embodiment, the picture elements may change color (for example, become light grey) if not available). In another embodiment, the picture elements may be dynamic, where the picture elements appear when available. For example, if an Internet connection is available, the cloud appears as a picture element. If the Internet connection is not available, the cloud is not visible as a picture element.

The progress pane 410 may indicate a sequence of steps that need to be accomplished to setup a server. As each step is completed, this may be indicated by bolding text associated with the step and highlighting text associated with the next step. Alternatively, an icon such as a checkbox may be used to indicate steps that have been completed by setup.

The information pane 415 may be used to display informational text regarding a setup and to gather configuration settings (e.g., server name, IP addresses, DNS addresses, gateway addresses, subnet masks, and so forth) from the system administrator. Next, previous, finished, and cancel buttons may also be displayed for interacting with a setup program.

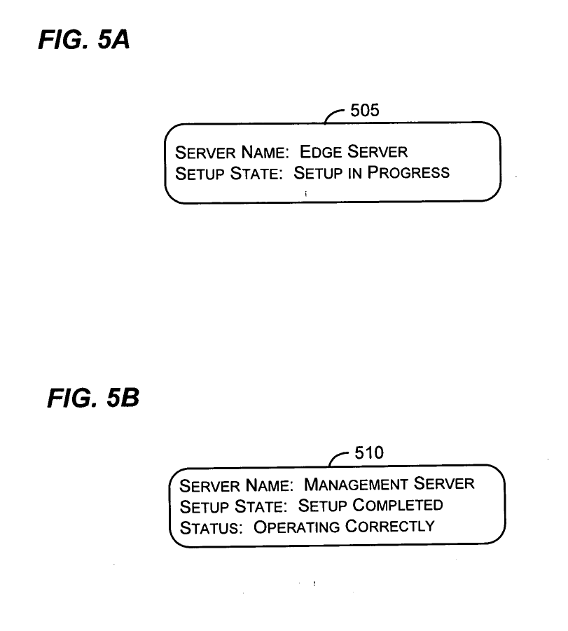

FIGS. 5A and 5B show exemplary illustrations of messages that may be displayed when an icon is hovered over or clicked on in accordance with aspects of the subject matter described herein. Turning to FIG. 5A a message 505 may be displayed when a user hovers or clicks an icon associated with an edge server that is currently being setup. Turning to FIG. 5B a message 510 may be displayed when a user hovers or clicks an icon associated with a management server when the management server has already been setup and is operating correctly.

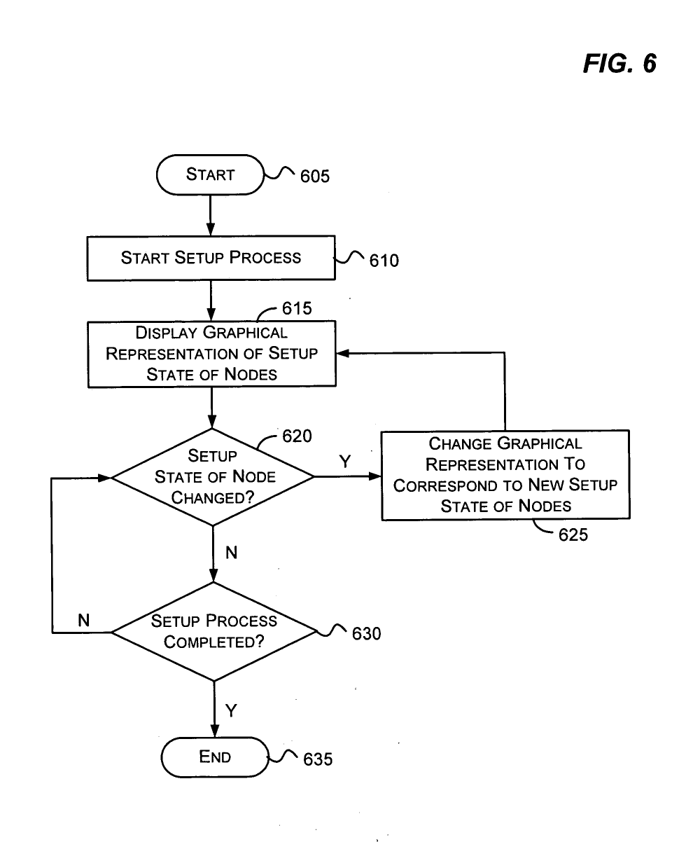

FIG. 6 is a flow diagram that generally represents exemplary actions that may occur during a setup process in accordance with aspects of the subject matter described herein. At block 605, the actions begin.

At block 610, a setup process is started. For example, referring to FIG. 2, a setup process may be started by inserting a DVD into the server 206 and executing a setup program contained on the DVD.

At block 615 a graphical representation of the setup state of the nodes is displayed. This may occur while the setup process is executing, for example. Referring to FIG. 4, a graphical representation 405 is displayed that indicates that two of the servers are configured to communicate with each other and other nodes and that a third server is not configured to communicate with the other servers or nodes. The graphical representation also indicates that one of the servers is currently being setup. In addition, the panes 410 and 415 indicate the steps that are currently taking place on the server that is currently being setup.

At block 620, a determination is made as to whether the setup state of any of the nodes has changed. If so, the actions continue at block 625; otherwise, the actions continue at block 630.

At block 625, the graphical representation is changed to correspond to the new setup state of the nodes. For example, if the second server completes its setup and a third server begins to be setup, this may be indicated by pointing an arrow at the third server (or otherwise highlighting it) and providing an indication that the second server has completed its setup.

At block 630, a determination is made as to whether the setup process has completed on all the nodes. If so, the actions continue at block 635; otherwise, the actions continue at block 620.

At block 635, the actions end. In another embodiment, the actions may continue until a user exits a setup state monitoring tool.

It should be understood that the actions described in conjunction with FIG. 6 are not all-inclusive of all the actions that may be taken in displaying a graphical representation of the setup state of nodes. Furthermore, although the actions are described in one embodiment as occurring in a particular order, in other embodiments, some of the actions may occur in parallel or may be performed in another order without departing from the spirit or scope of the subject matter described herein.

As can be seen from the foregoing detailed description, aspects have been described related to displaying a graphical representation of setup state. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
executing a setup process, wherein the setup process installs software components on a plurality of nodes that are to communicate with each other;
displaying a graphical representation of a setup state of each of the nodes, the graphical representation indicating at least a node currently being setup, whether each node is configured to communicate with other nodes, and whether each node has been setup via the setup process; and
changing the graphical representation as the setup process proceeds.

2. The computer-readable medium of claim 1, wherein the plurality of nodes comprises servers that provide services to other processes.

3. The computer-readable medium of claim 1, wherein the graphical representation indicating at least a node currently being setup comprises displaying an arrow pointing to an icon representing the node.

4. The computer-readable medium of claim 1, wherein the graphical representation indicating at least a node currently being setup comprises highlighting an icon representing the node.

5. The computer-readable medium of claim 1, wherein the graphical representation indicating whether each node is configured to communicate with other nodes comprises an animation of a graphic representing a network.

6. The computer-readable medium of claim 1, wherein the graphical representation indicating whether each node is configured to communicate with other nodes comprises at least one “X” graphic over a portion of a graphic representing a network, wherein the at least one “X” graphic is located next to each icon representing each node that is not configured to communicate with other nodes.

7. The computer-readable medium of claim 1, wherein the graphical representation indicating whether each node is configured to communicate with other nodes comprises at least one colored circle over a portion of a graphic representing a network, wherein the at least one colored circle is located next to each icon presenting each node that is configured to communicate with other nodes.

8. The computer-readable medium of claim 1, wherein the graphical representation indicating whether each node has been setup via the setup process comprises a shaded icon corresponding to each server that has not been setup via the setup process.

9. The computer-readable medium of claim 1, wherein the graphical representation indicating whether each node has been setup via the setup process comprises a colored area associated with each server that has been setup via the setup process.

10. The computer-readable medium of claim 1, further comprising displaying text regarding a state of node when a cursor is hovered over an icon representing the node or the icon is selected.

11. The computer-readable medium of claim 1, wherein the text includes a name, function, setup state of the node, and also includes a link to launch a document or website.

12. The computer-readable medium of claim 1, wherein the graphical representation includes a static picture element or a dynamic picture element that is visible based on an availability of an entity that the static or dynamic picture element represents.

13. A method implemented at least in part by a computer, the method comprising:
performing a setup of a plurality of nodes at least some of which are to provide services;
at least during the setup, displaying a graphical representation of a setup state of each node that is to provide a service; and
at least during the setup, changing the graphical representation to correspond to a current setup state of each node that is to provide a service.

14. The method of claim 13, wherein a setup state comprises not setup, currently being setup, completely setup, and functioning correctly.

15. The method of claim 13, wherein performing a setup of a plurality of nodes at least some of which are to provide services comprises logging on to each of the nodes that is to provide at least one service and installing software thereon to cause the node to provide the at least one service in response to a request for the at least one service.

16. The method of claim 13, wherein the graphical representation comprises an icon for each node that is to provide a service.

17. The method of claim 13, wherein the graphical representation comprises a graphic corresponding to a network connection of each node that is to provide a service.

18. The method of claim 13, wherein changing the graphical representation to correspond to a current setup state of each node that is to provide a service comprises changing the graphical representation to indicate whether each node is setup, currently being setup, or not setup and whether each node is configured to communicate with the other nodes of the plurality of nodes.

19. In a computing environment, an apparatus, comprising:
a user interface component arranged to receive input from a user and provide output to the user;
a configuration tool arranged to obtain setup status from other nodes and to cause the user interface to display a representation of the setup status of the other nodes; and
a communication component arranged to communicate with the other nodes in response to requests from the configuration tool, wherein the other nodes and a node upon which the configuration tool resides are part of a set of nodes upon which a setup process executes to setup the nodes to provide services.

20. The apparatus of claim 19, wherein the configuration tool is arranged to periodically poll the other nodes to obtain current setup status and to cause the user interface to display a current representation corresponding to the current setup status of the other nodes.
